(19) United States
(12) Patent Application Publication
(10) Pub. No.: US 2025/0307959 A1
(43) Pub. Date: Oct. 2, 2025

(54) LOGICAL DATA CENTER

(71) Applicant: Soluna Holdings, Inc., Albany, NY (US)

(72) Inventors: John Belizaire, Albany, NY (US); Dipul Patel, Albany, NY (US); Phillip Ng, Albany, NY (US); Mohamed Larbi Loudiyi, Albany, NY (US)

(21) Appl. No.: 19/098,442

(22) Filed: Apr. 2, 2025

Related U.S. Application Data
(60) Provisional application No. 63/573,248, filed on Apr. 2, 2024.

(51) Int. Cl. G06Q 50/06; G06Q 30/0202; H02J 3/00

(52) U.S. Cl. CPC G06Q 50/06; G06Q 30/0202; H02J 3/003; H02J 2300/28

(57) ABSTRACT

A method or system includes receiving, by a control system of a modular data center, data relating to performance of one or more computing processes. The control system determines, based on the received data, an optimization for execution of the one or more computing processes based upon the received data. The control system selects at least one computing process of the one or more computing processes for execution based upon the determination of optimization.

### CROSS REFERENCE TO RELATED APPLICATIONS

This Application claims the benefit of U.S. Provisional Patent Application No. 63/573,248, filed Apr. 2, 2024, the contents of which are incorporated by reference herein in its entirety as if fully set forth.

### FIELD

Illustrative embodiments generally relate to data centers and, more particularly, various embodiments of the invention relate to managing multiple data centers.

### BACKGROUND

Data centers are buildings or groups of buildings utilized by enterprises to house computer systems and associated components that contain critical applications and data. A data center supports a variety of business applications and activities, including email and file sharing, artificial intelligence, machine learning, and communications services. These activities are enabled through the infrastructure for network connectivity, central processing, and data storage within the data center.

### SUMMARY OF VARIOUS EMBODIMENTS

In accordance with one embodiment of the invention, a method includes receiving, by a control system of a modular data center, data relating to performance of one or more computing processes. The control system, based on the received data, determines an optimization for execution of the one or more computing processes based upon the received data, and selects at least one computing process of the one or more computing processes for execution based upon the determination of optimization.

In some embodiments, the received data comprises one or more of asset availability, asset status, electricity market conditions, and operational signals.

In some embodiments, the received data includes power output from one or more power sources.

In some embodiments, the one or more power sources is an alternative energy source.

In some embodiments, the alternative energy source is one or more of a wind farm or a solar farm.

In some embodiments, the determinization of optimization includes a determination of a profitability of the one or more computing processes.

In some embodiments, the determining an optimization includes forming one or more vectors or tuples.

In some embodiments, the one or more vectors or tuples include one or more of a computing process vector or tuple, an energy market signal vector or tuple, or a renewable resource availability vector or tuple.

In some embodiments, the determining of optimization includes determining one or more of a location in the modular data center for executing the at least one computing process.

In some embodiments, the executing of the at least one computing process includes executing in a time interval.

In accordance with one embodiment of the invention, a system includes a modular data center configured to execute one or more computing processes, and a control system operatively coupled with and in communication with the modular data center. The control system is configured to receive data relating to performance of one or more computing processes, determine based on the received data, an optimization for execution of the one or more computing processes based upon the received data, and select at least one computing process of the one or more computing processes for execution based upon the determination of optimization.

In some embodiments, the received data comprises one or more of asset availability, asset status, electricity market conditions, and operational signals.

In some embodiments, the received data includes power output from one or more power sources.

In some embodiments, the one or more power sources is an alternative energy source.

In some embodiments, the alternative energy source is one or more of a wind farm or a solar farm.

In some embodiments, the determinization of optimization includes a determination of a profitability of the one or more computing processes.

In some embodiments, the control system forms one or more vectors or tuples.

In some embodiments, the one or more vectors or tuples include one or more of a computing process vector or tuple, an energy market signal vector or tuple, or a renewable resource availability vector or tuple.

In some embodiments, the control system determines one or more of a location in the modular data center for executing the at least one computing process.

In some embodiments, the executing of the at least one computing process includes executing in a time interval.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows an example data center that may be configured in accordance with illustrative embodiments of the invention.

FIG. 2 schematically shows another embodiment of an example data center in accordance with illustrative embodiments.

FIG. 3 is a flow diagram of an example method of controlling computing processes in accordance with illustrative embodiments.

FIG. 4 schematically shows an example vector-based optimization methodology in accordance with illustrative embodiments.

FIG. 5 shows an example computing device in accordance with various embodiments.

### DESCRIPTION OF ILLUSTRATIVE EMBODIMENTS

Illustrative embodiments dynamically or statically combine a plurality of physical data centers into a logical data center. Among other ways, such embodiments may use various operational information, such as computational task requirements, power market conditions, as well as data center availability and capacity to assign entire physical data centers, or portions of physical data centers, into the logical data center. Details of illustrative embodiments are discussed below.

In illustrative embodiments, power sources output more power than can be utilized by loads. Accordingly, a control system of a modular data center (MDC) may determine computing processes based upon telemetry and power or energy output by a source (e.g., wind farm, solar farm, power grid, etc.) and select computing processes to consume the excess energy.

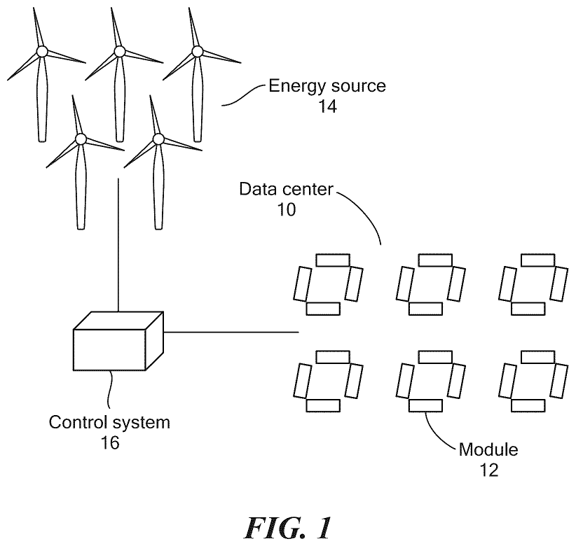

FIG. 1 schematically shows a data center 10 configured in accordance with illustrative embodiments of the invention. The data center 10 has a plurality of modules 12 arranged in a prescribed manner (discussed below) within a larger environment, and an energy source 14 to provide power to the modules 12, their internal electronic components (e.g., servers), and other data center components. In preferred embodiments, the energy source 14 is a renewable source, such as a wind energy farm (shown), solar farm, hydroelectric plant, etc.

In addition or alternatively, other embodiments may connect the data center 10 to a municipal or other conventional electric grid. This connection can be so-called “behind-the-meter” and/or “in-front-of-the-meter.” For example, such embodiments may use electricity from the conventional electric grid at times when utility electricity costs are lower, and then use renewable power when utility electricity costs are higher. In fact, even when using the conventional grid, the renewable energy source can generate and store energy in batteries or other means for future use (e.g., when the conventional electric grid costs are high), and/or sell excess renewably produced energy back to the conventional electric grid. Those skilled in the art should appreciate that the data center 10 can utilize a variety of other renewable energy and/or non-renewable energy sources and as such, those discussed in this description are for illustrative purposes only.

The data center 10 also has a control system 16 that, among other things, stores and manages the supply of electricity generated by the energy source 14. To that end, the control system 16 supplies electricity to the above noted plurality of modules 12 via the noted energy source(s) 14. This control system 16 may be pre-programmed to automatically select when and which energy source to use (e.g., the grid or local renewable and/or a microgrid), amounts, etc. In addition, the control system 16 may have user interfaces to facilitate manual grid control, as well as control of various control functions for managing the modules 12 and their systems.

In various embodiments, some or all of the modules 12 are permanently built in the environment. For example, each module 12 may be constructed with conventional building techniques and products that make moving the module 12 substantially permanent (i.e., analogous to a conventional house or office building). For example, each module 12 may be placed on a cement pad or foundation and secured in a substantially permanent manner to the ground. Indeed, there are cumbersome and extraordinary ways to move a permanent structure, such as a house, and the module design in such embodiments may be subject to moving such ways.

In other embodiments, however, the modules 12 are secured to the environment in a manner where they may be more readily moved, analogous to a trailer or some mobile homes. Specifically, they may be sized and placed in the environment with equipment that makes module movement more available. For example, a given module 12 may be placed on a prepared portion of the ground at the desired location in the environment and nominally secured with stakes, fasteners, or other techniques. To move a module 12 (e.g., to fine tune their positions for optimal position relative to the prevailing wind), workers or others may simply remove any ground (removably) coupling equipment and move the module 12 to the desired new location.

As mentioned above, various modules 12 may include computers or servers for executing various applications or functions. In some embodiments, computing processes may be connected to same or different power sources for operation. For example, in various embodiments, a first computing process may include an artificial intelligence (AI)/machine learning (ML) computing process, while a second computing process may include a batchable process (e.g., a BitCoin mining process). However, other computing processes may encompass the first computing process or second computing process.

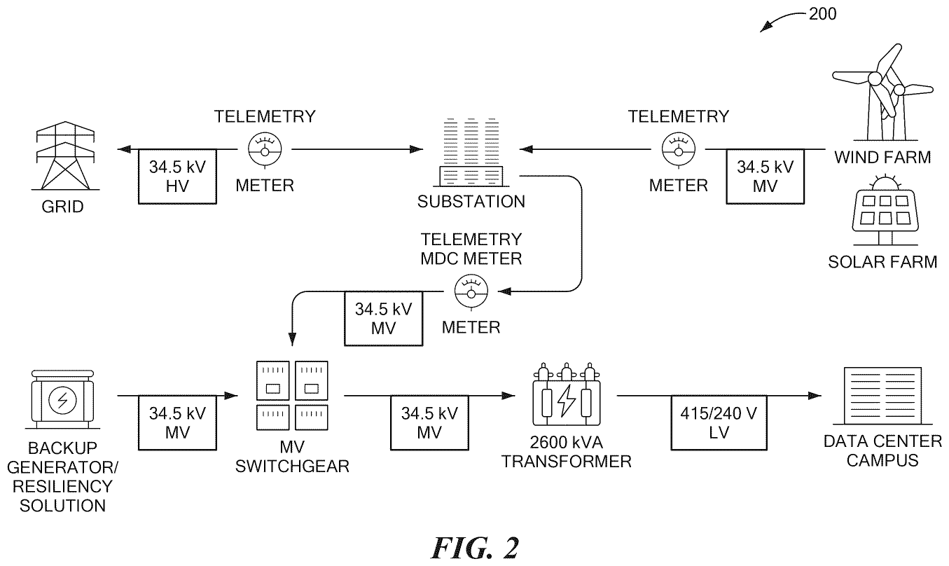

FIG. 2 schematically shows another embodiment of an example data center 200 in accordance with illustrative embodiments. As shown in FIG. 2, an electric grid (e.g., power grid) is connected to a substation to provide electrical power to loads. The electric grid may be part of an interconnect that is supplied with electrical power by a number of generating stations.

In various embodiments, the substation may also receive power from alternative energy generating sources, (e.g., wind farms, solar farms, etc.). These alternative energy generating sources provide energy for consumer use via the grid. In various embodiments, these alternative energy sources may be contractually obligated to provide a threshold amount of electrical energy. In various embodiments, these alternative energy sources may be utilized to provide power to loads without going through the grid (e.g., “behind the grid”).

Also shown in FIG. 2 is a data center campus (e.g., modular data center “MDC”), a transformer, medium voltage (MV) switchgear, and a backup generator. It should be noted that the components depicted are exemplary and more or less components may be included in the example data center 200.

For example, the example data center 200 may not include a power grid connection or backup generator. In addition, various components are shown having example values (e.g., the transformer being 2600 kVA), however, the values are exemplary only and persons of skill in the art may appreciate that other values may be utilized for the components shown in FIG. 2.

Continuing to refer to FIG. 2, the electrical grid and alternative energy sources (e.g., wind farm, solar farm) provide electrical power/energy to the substation. The substation converts the power to a voltage for use by various loads. In the example shown in FIG. 2, the electrical grid provides power at around 345 kV (high voltage “HV”), for example, while the alternative energy sources provide power at around 34.5 kV (medium voltage “MV”). In various embodiments, the substation transforms higher voltages (e.g., 345 kV) into a lower voltage, such as 34.5 kV.

The energy received at the switchgear is, accordingly, 34.5 kV, for example. In various embodiments, the switchgear also receives 34.5 kV power from the backup generator/resiliency solution, which provides power to the data center campus upon a reduction in power from either the electrical grid and/or alternative energy sources.

In various embodiments the switchgear provides power to the transformer, which converts the voltage to a voltage level for use by the data center campus. For example, as shown in FIG. 2, the transformer transforms the 34.5 kV distribution voltage to a secondary voltage (low voltage “LV”) of around 415/240 volts.

As mentioned above, the example data center 200 may include only the alternative energy source, switchgear, transformer and data center campus for purposes of example.

Also shown in FIG. 2 are one or more meters from which telemetry may be obtained regarding the power (e.g., kWh) being produced/provided at various regions. In various embodiments, telemetry regarding the grid power, alternative energy power, and/or substation power may be provided in order to determine strategies for the example method described herein.

Accordingly, in various embodiments, FIGS. 1 and 2 schematically show a modular data center (“MDC”) 10 configured in accordance with illustrative embodiments. As mentioned above, the annotations and specific numbers of FIG. 2 are exemplary and not intended to limit various embodiments. The MDC 10 has a plurality of modules 12 arranged in a prescribed manner and an energy source 14, which in various embodiments is an alternative energy source as described above, to provide power to the modules 12 and other data center components. In various embodiments, the alternative energy source may be a renewable source, such as a wind energy farm (shown), solar farm (shown), hydroelectric plant, etc. Those skilled in the art may appreciate that the data center 10 can utilize a variety of other renewable energy and/or non-renewable energy sources. The energy source thus also can include the public grid as described above in FIG. 2. This modular structure can be rapidly deployed in remote locations with minimal infrastructure requirements-just power and networking. These systems are flexible and can dynamically adapt to the availability of power and cloud computing demand to accommodate variable energy, remote operation, real-time grid management, and interconnection requirements.

Referring back to FIG. 1, the data center 10 also has the control system 16 that may store and/or manage the supply of electricity generated by the energy source. To that end, the control system 16 supplies electricity to one or more sets of a plurality of modules 12 that each has a housing with an interior. Although the module housing of various embodiments may be implemented as a rectangular metal container, they alternatively may have other form factors and/or be formed from wood, plastic, concrete other structural materials, or a combination of materials. The housing is a substantially enclosed, vented structure that provides shelter to its interior components from the environment. In various embodiments, the housing is structured so that the module 12 is portable and thus, it can be transported to different locations. Other embodiments, however, may apply to non-modular designs and as such, discussion of a modular design is by example only and not intended to apply to all embodiments.

To provide its core function, the interior of the housing contains a plurality of processing devices. In various embodiments, among other things, the processing devices include computers, servers, networking equipment (e.g., switches and routers), graphics accelerators (e.g., video graphics cards), and high-performance computing components, as well as various information security elements, such as firewalls. Those skilled in the art may understand that these components are illustrative and there is a variety of hardware, software, and combinations of hardware and software that can establish the functional components of a processing device and related accessories. The processing devices contained within the modules perform any of a variety of common functions to support applications, such as blockchain computing, web services, video or other multi-media transmission, storage, and data management.

As shown in the embodiments of the figures, the MDCs 12 are logically and/or physically meshed together to create cloud computing resources for specific types of applications (e.g., Web 3.0 applications, Bitcoin mining, AI/ML processing, etc.). Since MDC computing resources may be intermittent, they can be deployed as a complementary extension of traditional computing resources by coupling them together in a reliable manner, such as via a high-speed network to share a single filesystem, workload, and scheduler. Jobs submitted to the shared queue are seamlessly scheduled to the ensemble.

To the cloud computing consumer, an MDC looks like any other cloud platform (albeit typically much more efficient), as the software layer seamlessly manages load and demand to prioritize and complete tasks. This software layer handles real-time prioritization and scheduling of tasks across multiple MDCs while allowing the compute resources to turn on and off as needed. Additionally, the system manages power quality requirements such as transients, interruptions, voltage sags and swells, and frequency variations.

In various embodiments, each MDC 12 is a standalone data center with its own local control system that responds to real-time inputs, such as intermittent local power availability, energy market signals, and physical asset condition monitoring. The MDCs themselves are composed of arrays of modular computing units (i.e., self-contained boxes with computing equipment) that are integrated into thermal management and asset monitoring systems.

For a given installation site, there may be several MDC structures that are operated together to create larger physically clustered sub-networks (Pods) that are located near a renewable generation plant. For instance, ten large MDCs can be combined into a farm that consumes over 30MW of peak power. The computing resources in each MDC can provide distributed computing resources for high-performance computing jobs on a standalone basis, or they can be virtually meshed together (both within the same physical vicinity and across different geographies) to become one large supercomputer running in unison.

To that end, in various embodiments, a software-defined network mesh combines a global distributed network of MDCs into a single cloud computing fabric that is resilient to locationally intermittent power availability while providing sufficient computational uptime and performance for batchable cloud computing tasks. The data centers' power availability may be intermittent, as the energy demand from the MDCs is co-optimized with physically co-located intermittent power generation (e.g., wind and solar). Alternative embodiments may also use traditional data centers (e.g., large, fixed buildings using traditional power sources, such as the grid) in the software-defined mesh. Whereas cloud computing tasks traditionally require a high level of data center uptime (e.g., 99.9%), by leveraging its software-defined network mesh, illustrative embodiments are able to run the same computational tasks seamlessly in an environment where individual data centers have a less reliable uptime (e.g., about 85% uptime) due to intermittent power availability. By meshing diversified MDC clusters (geographically dispersed and/or with different power availability profiles) into a virtual cloud computing fabric, the cloud computing service achieves a meaningfully higher effective aggregate uptime, such as 95 percent uptime.

In various embodiments, an optimization sequence allocates a heterogeneous stream of high-performance, batchable computing jobs to cloud computing nodes (i.e., specific physical equipment) at preferred locations and times (e.g., most efficient locations and times or “best available” locations and times) such that the computing jobs are performed at the lowest possible cost and within the job requirements (e.g., turnaround time, turnaround certainty, computational performance).

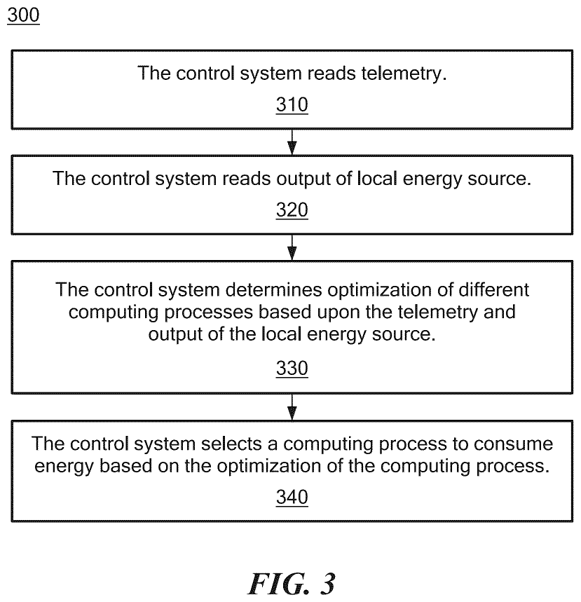

FIG. 3 is a flow diagram of an example method 300 of controlling computing processes in accordance with illustrative embodiments. In various embodiments, the method 300 may include, at block 310, the reading of telemetry by the control system (e.g., control system 16). That is, in various embodiments, the control system ascertains and forecasts situational awareness (e.g., of renewable energy resource availability, energy market conditions, asset health, computing requirements, etc.).

At block 320, the control system reads the output of local energy sources. In various embodiments, the output may be the output of the grid and/or alternative energy sources.

Accordingly, once the control system has obtained any telemetry and the energy output of the energy sources, at block 330, the control system determines an optimization of different computing sources based upon the telemetry and/or output of the local energy source or sources. That is, the control system includes a situational awareness of factors in the system (e.g., grid, alternative energy source, etc.) to optimize allocation of computational tasks (e.g., by determining profitability of different computing processes).

In various embodiments, the control system determines the optimal allocation of computational tasks (e.g., where and when to allocate the computing work). That is, the control system may receive diverse streams of stochastic information that can be either real-time or forecasted, either directly measured or reported from third-parties, and either actual based on sensor measurements or estimated with statistical methods.

In various embodiments, the situational awareness may include a variety of monitored factors, such as renewable energy resource availability (e.g., wind speed, solar irradiation), energy market conditions (e.g., nodal prices, unit commitments, dispatch signals, transmission congestion, outages, etc.), asset health monitoring (e.g., power quality, operating temperatures, maintenance alerts, security cameras, etc.), computing workloads (i.e., workload traces, discrete-event simulations, expected workload fluctuations, etc.), and computing equipment availability (i.e., performance scaling, planned outages, etc.).

In various embodiments, the situational awareness may be represented as metrics. For example, the situational awareness may be represented as thresholds (e.g., triggered when value exceeds a given parameter), statistical inferences, such as moving averages or correlations, complex patterns derived from the data or combinations of data (e.g., using machine learning), human-based interpretation, or some other analytical derivative.

In various embodiments, an analytical derivative may process data from one or more sources (e.g., the telemetry and output measurements of blocks 310 and 320) and produce information about the current or expected future state of variables affecting the (optimal) allocation of computation tasks to specific MDCs and MDC clusters at specific times and in specific ways (e.g., interruptible versus reliable, scalable versus constant performance, etc.).

Accordingly, at block 340, the control system selects a computing process to consume energy based on, for example, the optimization of the computing process. In various embodiments, the control system implements the computational task allocation reliably (e.g., correctly on a consistent basis) and efficiently (e.g., without incurring unnecessary delays that waste computing resources and reduce overall computational performance metrics such as job turnaround times).

In various embodiments, the control system leverages outputs from the situational awareness process as input variables into a vector-based optimization sequence. In various embodiments, the computational task allocation and scheduling methodology of block 340 may consider some or all of the available information to determine a number of operating decisions. For example, the operating decisions may include at which MDC location, on what equipment, when to run a given computational task, how long the computational task needs to run until it is completed or reaches its next interruptible point, and/or how much to charge (e.g., money) for the computational work performed.

One or more of the aspects relevant to an optimal allocation of computing tasks (e.g., energy market signals, renewable resource availability, asset health, etc.) may be defined in a manner such as a tuple (or vector) of variables that represent each of the common parameters quantifying that relevant aspect. The vectors are then configured into a solvable system of equations having a solution that is a feasible vector space and a set of potential optima. The optimization sequence then selects and validates from a plurality of options, preferably selecting and validating the most optimal allocation of computing tasks from the solution set based on proprietary heuristics.

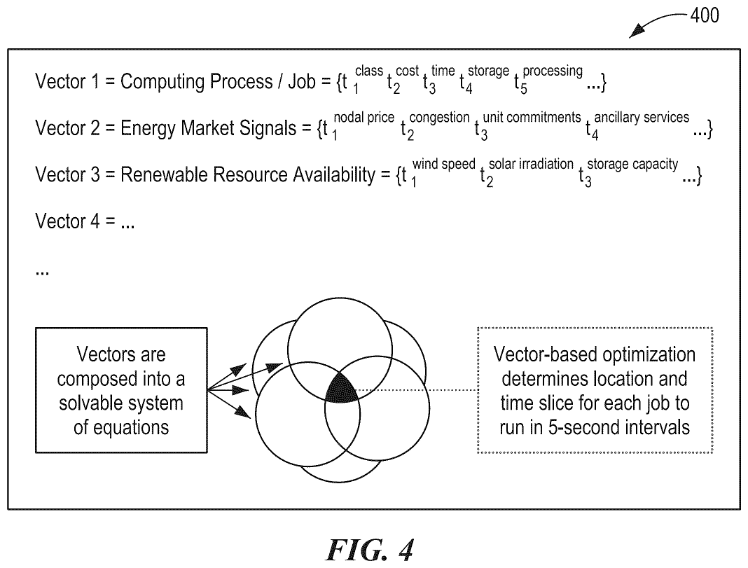

FIG. 4 schematically shows an example vector-based optimization methodology 400 in accordance with illustrative embodiments. As shown in FIG. 4, several vectors may be utilized to determine an optimization, such as a computing process/job, energy market signals, renewable resource availability, etc. The vectors are composed into a solvable system of equations and the vector-based optimization determines a location and time slice for each job to run (e.g., in 5 second intervals).

As shown in FIG. 4, in various embodiments, the computing process/job vector may include one or more of a class, cost, time, storage and/or processing component. In various embodiment, the energy market signals vector may include one or more of a nodal price, congestion, unit commitments and/or ancillary services component. In various embodiments, the renewable resource availability vector may include one or more of a wind speed, solar irradiation and/or storage capacity component.

Table 1 below illustrates an exemplary set of parameters that may be the basis for a vector that represents the requirements of a given computational job. There are several different classes of computational jobs (e.g., crypto, artificial intelligence, machine learning, video rendering, scientific computing, etc.) each with varying requirements such as processing power, memory, security, budget limits, and other considerations that pertain to cloud computing jobs.

TABLE 1
Exemplary vector parameters for a
computational job

| Attribute | Values |
|---|---|
| Class | Crypto, AI, ML |
| Budget | $30-400/hr |
| Duration | 0-24 hours |
| Storage needed | Terabytes |
| CPU speed needed | Ghz |

So a job J = {j-class, j-duration, j-budget, j-storage, j-cpu, . . . }

Table 2 below illustrates an exemplary set of parameters that may be the basis for a vector that represents the availability (e.g., amount of computing capacity available as measured by memory, CPU speed, GPUs, storage capacity, etc.) and status (e.g., asset health as measured by operating temperature, power consumption, physical or cyber security alerts, etc.) of an individual MDC, and/or a cluster of MDCs. In another embodiment, the vector may represent a computing fabric that is a virtual aggregation of MDCs or MDC clusters.

TABLE 2
Exemplary vector parameters for MDC
availability and status

| Attribute | Values |
|---|---|
| Classes available | Crypto, HPC |
| Storage available | Terabytes |
| Capacity factor | 80-99% |
| CPU speed available | Ghz |
| Temperature | Nominal, |
| | Warning, Critical |

So an MDC M = {m-class, m-storage, m-capfactor, m-cpu, m-temp, . . . }

Table 3 below illustrates an exemplary set of parameters that may be the basis for a vector that represents electricity market conditions (e.g., locational prices at different nodes, transmission congestion, etc.) and operational signals (e.g., dispatch instructions from the system operator, area control error for frequency regulation). These parameters may impact the amount of energy that the MDCs consume and how much of that consumption comes from local power generation sources located within the same substation circuit (or behind the meter) as opposed to procured from the wholesale market.

TABLE 3
Exemplary vector parameters for
energy market signals

| Attribute | Values |
|---|---|
| LMP | −100-+65 |
| IPP output | Megawatts hours |
| Capacity factor | 35-40% |
| Ancillary revenue | $ per MW |
| Reserve margin | 35% |

So E = {e-lmp, e-ipp, e-capacityfactor, e-ancrev, e-wacc, . . . , . . . }

With all the vectors defined and situational awareness established, illustrative embodiments can run an optimization solver that determines an allocation of computational tasks to specific MDCs at specific times according to a variety of constraints and objective functions. Preferably, this allocation is the optimal allocation for the noted purposes.

Prior to running the optimization algorithm, the individual vectors (or tuples) may be configured into a vector of vectors that embodies a solvable system of equations, as mentioned above. In illustrative embodiments, the optimization solver then runs a sequence of best-fit, fit-to-model, and heuristic-based algorithms to find the allocation of computational tasks that has the desired outputs. Among others, those desired outputs may include an allocation that most minimizes cost, maximizes asset utilization, minimizes risk of task failures, maximizes energy market revenues, and so on. The optimization solver can run intermittently or continuously to iteratively optimize job schedules every given time interval (e.g., 5 seconds or 5 minutes) such that the task allocation for the software-defined network mesh is continually optimized according to the most recent situational awareness. If a job is no longer optimal in an MDC, the scheduler can determine, based on the remaining time on the job's j-duration attribute and/or other relevant attributes, to move it elsewhere.

The optimization sequence then implements solutions, sending electronic files and instructions through the network to cause work to happen in the desired manner.

Those skilled in the art may use other techniques to mesh the MDCs into a logical resource. Accordingly, discussion of the noted techniques above is one of a plurality of ways.

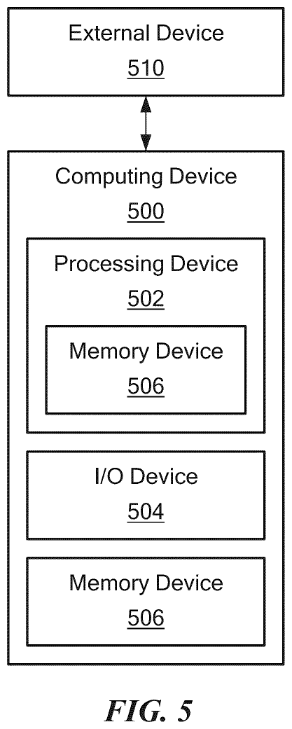

FIG. 5 schematically shows a computing device 500 in accordance with various embodiments. The computing device 500 is one example of one of the devices in the eye tracking system 120 a computing device which is used to perform one or more operations of process 200 illustrated in FIG. 2. The computing device 500 includes a processing device 502, an input/output device 504, and a memory device 506. The computing device 500 may be a stand-alone device, an embedded system, or a plurality of devices configured to perform the functions described with respect to one of the components of power network 100. Furthermore, the computing device 500 may communicate with one or more external devices 510.

The input/output device 504 enables the computing device 500 to communicate with an external device 510. For example, the input/output device 504 may be a network adapter, a network credential, an interface, or a port (e.g., a USB port, serial port, parallel port, an analog port, a digital port, VGA, DVI, HDMI, FireWire, CAT 5, Ethernet, fiber, or any other type of port or interface), among other things. The input/output device 504 may be comprised of hardware, software, or firmware. The input/output device 504 may have more than one of these adapters, credentials, interfaces, or ports, such as a first port for receiving data and a second port for transmitting data, among other things.

The external device 510 may be any type of device that allows data to be input or output from the computing device 500. For example, the external device 510 may be a meter, a control system, a sensor, a mobile device, a reader device, equipment, a handheld computer, a diagnostic tool, a controller, a computer, a server, a printer, a display, a visual indicator, a keyboard, a mouse, or a touch screen display, among other things. Furthermore, the external device 510 may be integrated into the computing device 500. More than one external device may be in communication with the computing device 500.

The processing device 502 may be a programmable type, a dedicated, hardwired state machine, or a combination thereof. The processing device 502 may further include multiple processors, Arithmetic-Logic Units (ALUs), Central Processing Units (CPUs), Digital Signal Processors (DSPs), or Field-programmable Gate Arrays (FPGA), among other things. For forms of the processing device 502 with multiple processing units, distributed, pipelined, or parallel processing may be used. The processing device 502 may be dedicated to performance of just the operations described herein or may be used in one or more additional applications. The processing device 502 may be of a programmable variety that executes processes and processes data in accordance with programming instructions (such as software or firmware) stored in the memory device 506. Alternatively or additionally, programming instructions are at least partially defined by hardwired logic or other hardware. The processing device 502 may be comprised of one or more components of any type suitable to process the signals received from the input/output device 504 or elsewhere, and provide desired output signals. Such components may include digital circuitry, analog circuitry, or a combination thereof.

The memory device 506 in different embodiments may be of one or more types, such as a solid-state variety, electromagnetic variety, optical variety, or a combination of these forms, to name but a few examples. Furthermore, the memory device 506 may be volatile, nonvolatile, transitory, non-transitory or a combination of these types, and some or all of the memory device 506 may be of a portable variety, such as a disk, tape, memory stick, or cartridge, to name but a few examples. In addition, the memory device 506 may store data which is manipulated by the processing device 502, such as data representative of signals received from or sent to the input/output device 504 in addition to or in lieu of storing programming instructions, among other things. As shown in FIG. 5, the memory device 506 may be included with the processing device 502 or coupled to the processing device 502, but need not be included with both.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments described above are intended to be merely exemplary; numerous variations and modifications will be apparent to those skilled in the art. Such variations and modifications are intended to be within the scope of various embodiments.

What is claimed is:

1. A method comprising:
receiving, by a control system of a modular data center, data relating to performance of one or more computing processes;
determining, by the control system, based on the received data, an optimization for execution of the one or more computing processes based upon the received data; and
selecting, by the control system, at least one computing process of the one or more computing processes for execution based upon the determination of optimization.

2. The method of claim 1, wherein the received data comprises one or more of asset availability, asset status, electricity market conditions, and operational signals.

3. The method of claim 1, wherein the received data includes power output from one or more power sources.

4. The method of claim 3, wherein the one or more power sources is an alternative energy source.

5. The method of claim 4, wherein the alternative energy source is one or more of a wind farm or a solar farm.

6. The method of claim 1, wherein the determinization of optimization includes a determination of a profitability of the one or more computing processes.

7. The method of claim 1, wherein the determining an optimization includes forming one or more vectors or tuples.

8. The method of claim 7, wherein the one or more vectors or tuples include one or more of a computing process vector or tuple, an energy market signal vector or tuple, or a renewable resource availability vector or tuple.

9. The method of claim 8, wherein the determining of optimization includes determining one or more of a location in the modular data center for executing the at least one computing process.

10. The method of claim 9, wherein the executing of the at least one computing process includes executing in a time interval.

11. A system, comprising:
a modular data center configured to execute one or more computing processes; and
a control system operatively coupled with and in communication with the modular data center, the control system configured to receive data relating to performance of one or more computing processes, determine based on the received data, an optimization for execution of the one or more computing processes based upon the received data, and select at least one computing process of the one or more computing processes for execution based upon the determination of optimization.

12. The system of claim 11, wherein the received data comprises one or more of asset availability, asset status, electricity market conditions, and operational signals.

13. The system of claim 11, wherein the received data includes power output from one or more power sources.

14. The system of claim 13, wherein the one or more power sources is an alternative energy source.

15. The system of claim 14, wherein the alternative energy source is one or more of a wind farm or a solar farm.

16. The system of claim 11, wherein the determinization of optimization includes a determination of a profitability of the one or more computing processes.

17. The system of claim 11, wherein the control system forms one or more vectors or tuples.

18. The system of claim 17, wherein the one or more vectors or tuples include one or more of a computing process vector or tuple, an energy market signal vector or tuple, or a renewable resource availability vector or tuple.

19. The system of claim 18, wherein the control system determines one or more of a location in the modular data center for executing the at least one computing process.

20. The system of claim 19, wherein the executing of the at least one computing process includes executing in a time interval.

21. A computer program product for use on a computer system, the computer program product comprising a tangible, non-transient computer usable medium having computer readable program code thereon, the computer readable program code comprising:
program code for receiving, by a control system of a modular data center, data relating to performance of one or more computing processes;
program code for determining, by the control system, based on the received data, an optimization for execution of the one or more computing processes based upon the received data; and
program code for selecting, by the control system, at least one computing process of the one or more computing processes for execution based upon the determination of optimization.

22. The computer program product of claim 1, wherein the received data comprises one or more of asset availability, asset status, electricity market conditions, and operational signals.

23. The computer program product of claim 21, wherein the received data includes power output from one or more power sources.

24. The computer program product of claim 23, wherein the one or more power sources is an alternative energy source.

25. The computer program product of claim 24, wherein the alternative energy source is one or more of a wind farm or a solar farm.
